(19) United States
(12) Patent Application Publication
(10) Pub. No.: US 2006/0196164 A1
(43) Pub. Date: Sep. 7, 2006

(54) Dual mode turbo engine

(76) Inventor: Thomas F. Donohue, Cincinnati, OH (US)

Correspondence Address: Steven J. Rosen;Patent Attorney, 4729 Cornell Rd., Cincinnati, OH, 45241, US

(21) Appl. No.: 11/070,900

(22) Filed: Mar. 3, 2005

(51) Int. Cl. F02K 3/04

(52) U.S. Cl. 60/226.1; 60/791

(57) ABSTRACT

A dual mode gas turbine engine includes a dual mode fan and low pressure compressor section upstream of radially inner and outer gas generators which include radially inner and outer combustors disposed in radially inner and outer working fluid flowpaths, respectively, in fluid flow communication with the dual mode fan and low pressure compressor section. An outer low pressure turbine downstream of the outer combustor is drivingly connected to the fan and low pressure compressor section. A common exhaust duct downstream of the inner and outer gas generators is in fluid flow communication with the flowpaths. The outer low pressure turbine may include outer low pressure turbine blades mounted on a rotatable turbine shroud connected to a low pressure rotor which includes the fan and low pressure compressor section. Inner low pressure turbine blades on the low pressure rotor and downstream of a diffusing duct extend across the inner working fluid flowpath and connect the turbine shroud to the low pressure rotor.

### BACKGROUND OF THE INVENTION

### Field of the Invention

This invention relates to aircraft gas turbine engines and, more particularly, to variable cycle gas turbine engines.

Two basic variations of aircraft gas turbine engines developed for powering aircraft at speeds that approach or exceed Mach 1 are turbojet and turbofan engines. A turbojet engine's turbine receives combustion gases and extracts only the power required to drive a compressor and accessories necessary for continuous operation. The remaining power of the combustion gases is used to provide forward thrust by accelerating the gases through an exhaust nozzle at a downstream end of the engine. The turbojet engine is particularly effective for supersonic flight, developing the high specific thrust necessary for powering aircraft at speeds in excess of Mach 1.

A turbofan engine's turbine extracts power from the combustion gases to drive a compressor and accessories and extracts additional power in order to drive a fan section that accelerates air to provide forward thrust for the aircraft. The air accelerated by the fan is called bypass air because it bypasses core engine or gas generator containing a combustor for burning or combusting fuel with compressed air, air compressed by the fan and compressor. The turbofan engine is best suited for powering aircraft at speeds approaching but not attaining Mach 1. A great deal of effort has been directed at developing a gas turbine engine with the attributes of both a turbojet and a turbofan. Ideally, an engine would have the high specific thrust characteristics of a turbojet, but could also be configured to exhibit the lower specific thrust, and better fuel consumption characteristics of a turbofan. Such characteristics can be greatly beneficial to mixed-mission type aircraft requiring both high and low speed operation.

Engines that are suitable for these mixed-missions have been developed in various forms with varying degrees of success. Low bypass turbofans of fixed geometry are in current production—and even more operative flexibility has been obtained with variable cycle engines in which the amount of air that is bypassed is changed to efficiently match power requirements based on aircraft speed. Variable bypass systems have been developed for use in military engines with and without augmenters (afterburners) to provide additional thrust at supersonic speeds. Afterburning turbofan engines typically utilize mixers that take part of the engine's bypass air and mix or inject that air into the core engine flow in an engine's afterburning section. This allows more of the total engine airflow to be utilized with the afterburner for maximum thrust potential and also permits the use of a single throat variable exhaust nozzle. In these afterburning engines, a substantial portion of the bypass flow is devoted to augmenter and nozzle cooling. Variable cycle engines that vary the amount of bypass air injected at the afterburner region can obtain significant performance advantages. Total bypass flow is increased at dry (non-augmented) operating conditions and reduced at augmented conditions. Under dry conditions, the engine is operated to improve specific fuel consumption and during augmented conditions to improve thrust. High performance variable cycle gas turbine engines are being designed because of their unique ability to operate efficiently at various thrust settings and flight speeds both subsonic and supersonic.

Today mixed-mission manned and unmanned aircraft are evolving. These aircraft require efficiently operating engines that can fly quickly to a distant location and then loiter for considerable periods of time, thus having the dual requirements of thrust and fuel efficiency. Fast flying aircraft, especially supersonic aircraft, typically require afterburners while slow flying aircraft able to loiter for long periods of time require highly fuel efficient engines. Afterburners consume a great deal of fuel when operating. Thus, it is highly desirable to provide an aircraft gas turbine engine which can be operated at high thrust without an afterburner and also be able to operate at very low power for prolonged periods of time with good efficiency.

### SUMMARY OF THE INVENTION

A dual mode gas turbine engine includes a dual mode fan and low pressure compressor section upstream of radially inner and outer gas generators having inner and outer working fluid flowpaths including radially inner and outer combustors respectively in fluid flow communication with the dual mode fan and low pressure compressor section. An outer low pressure turbine downstream of the outer combustor is drivingly connected to the fan and low pressure compressor section.

An exemplary embodiment of the engine includes a common exhaust duct downstream of the radially inner and outer gas generators and in fluid flow communication with the inner and outer working fluid flowpaths. Outer low pressure turbine blades of the outer low pressure turbine are mounted on a rotatable turbine shroud connected to a low pressure rotor of the engine which includes the fan and low pressure compressor section and the outer low pressure turbine.

The inner gas generator includes an inner low pressure turbine with inner low pressure turbine blades supporting the rotatable turbine shroud on the low pressure rotor. The inner working fluid flowpath includes a rotating flowpath having passages between the inner low pressure turbine blades supporting the rotatable turbine shroud on the low pressure rotor. Alternatively, substantially structural struts may be used to support the rotatable turbine shroud on the low pressure rotor instead of the inner low pressure turbine blades.

The outer low pressure turbine may include a disk with a disk rim connected to a disk root by a disk web with the struts mounted around the disk rim. The inner low pressure turbine having two or more inner low pressure turbine stages. The radially inner gas generator may include a high pressure compressor with a radial outflow centrifugal compressor stage. The inner combustor may be a reverse flow annular combustor that may incorporate a trapped vortex cavity combustor. The engine may also incorporate an electrical generator having an electrical generator rotor mounted to the low pressure rotor.

The dual mode gas turbine engine can be operated at high thrust dry (without an afterburner) and also be able to loiter for prolonged periods of time. The engine can operate at very low output with good efficiency and operate at both high speed (supersonic) flight at high altitude over considerable distances and low speed low altitude flight of substantial duration.

### BRIEF DESCRIPTION OF THE DRAWINGS

The foregoing aspects and other features of the invention are explained in the following description, taken in connection with the accompanying drawings where:

FIG. 1 is a schematical cross-sectional view illustration of a dual mode aircraft gas turbine engine having a dual mode fan and low pressure compressor section upstream of a radially inner gas generator and an outer gas generator with an outer low pressure turbine including a disk drivingly connected to the fan and low pressure compressor section.

FIG. 2 is a schematical perspective view illustration of inner and outer low pressure turbine blades mounted to a low pressure rotor and drivingly connected to the fan and low pressure compressor section illustrated in FIG. 1.

FIG. 3 is a schematical cross-sectional view illustration of an exemplary alternative inner low pressure turbine having more than one stage of inner low pressure turbine blades.

### DETAILED DESCRIPTION OF THE INVENTION

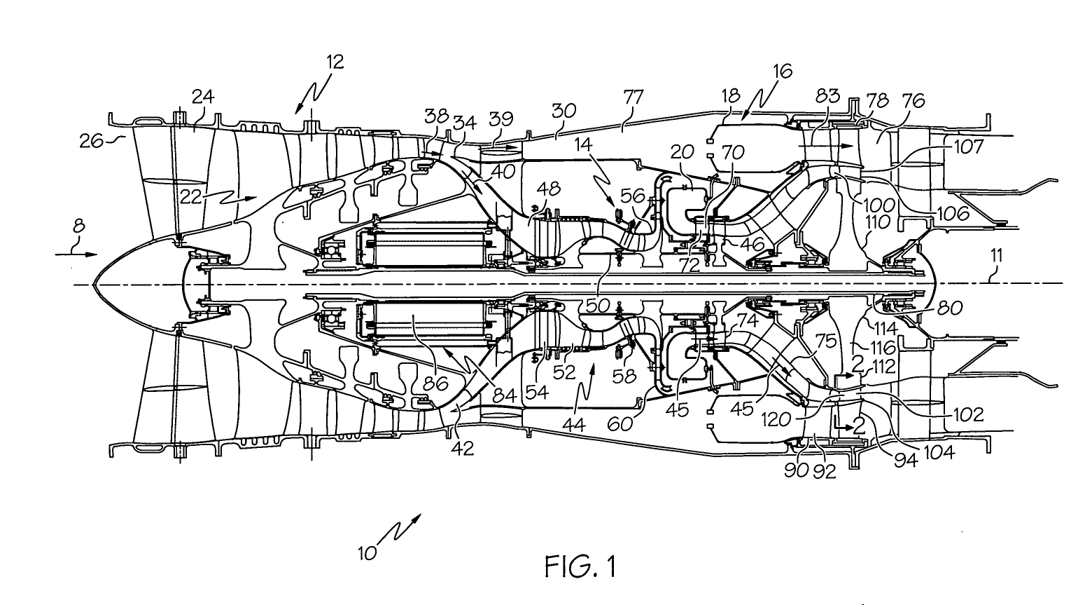

Schematically illustrated in cross-section in FIG. 1 is an exemplary embodiment of a dual mode aircraft gas turbine engine 10 circumscribed about an engine axis or engine centerline 11 and having a dual mode fan and low pressure compressor section 12 upstream of radially inner and outer gas generators 14 and 16 having radially inner and outer combustors 18 and 20, respectively. The fan and low pressure compressor section 12 operates both as a fan and a low pressure compressor to both accelerate and compress ambient air 8 entering the engine 10 through an engine inlet 26. The fan and low pressure compressor section 12 is illustrated as having a single direction of rotation and three fan and low pressure compressor stages 22 downstream of variable inlet guide vanes 24 in the inlet 26 of the engine 10.

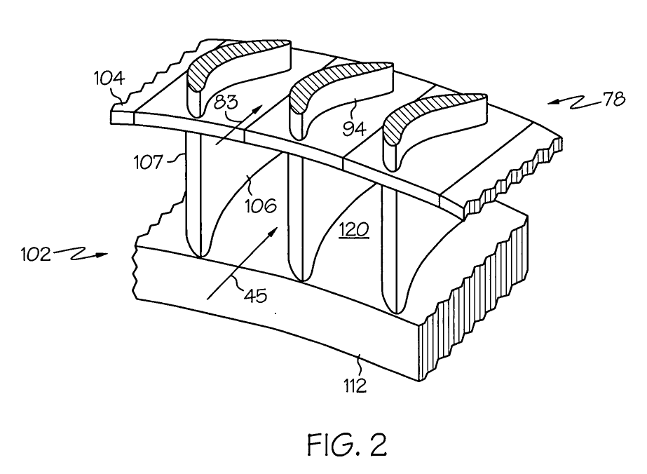

A radially outer bypass duct 30 surrounds the inner gas generator 14, which may also be referred to as a core engine, downstream and axially aft of the fan and low pressure compressor section 12. A flow splitter 34 is used to divide fan and low pressure compressor flow 38 discharged from the fan and low pressure compressor section 12 into bypass airflow 39 entering the bypass duct 30 and core engine airflow 40 entering an annular core engine inlet 42 leading to the core engine or inner gas generator 14. The inner gas generator 14 includes an inner working fluid flowpath 48 and in downstream serial flow relationship a high pressure compressor 44, the radially inner combustor 18, and an inner high pressure turbine 46 and, in the exemplary embodiments of the engine 10 illustrated in FIGS. 1 and 2, an inner low pressure turbine 82. A high pressure rotor 50 includes the inner high pressure turbine 46 and the high pressure compressor 44 and drivingly connects the inner high pressure turbine 46 to the high pressure compressor 44 through the high pressure rotor 50.

The high pressure compressor 44 is illustrated as having a high pressure compressor axial first stage 52 preceded by and downstream from a high pressure compressor first variable vane stage 54. The high pressure compressor 44 is illustrated as having a high pressure compressor second variable vane stage 58 followed by and upstream from a high pressure compressor second stage 56, both which are downstream from the high pressure compressor axial first stage 52. The high pressure compressor second stage 56 is a radial outflow centrifugal compressor stage 60 leading to the inner combustor 18 illustrated herein as a reverse flow annular combustor that may incorporate a trapped vortex cavity combustor design.

Downstream of the inner combustor 18 is the inner high pressure turbine 46. Pressurized air from the high pressure compressor 44 is mixed with fuel in the inner combustor 18 and ignited, thereby, generating inner combustion gases 45 that are flowed to the inner high pressure turbine 46, which in turn, powers the high pressure compressor 44. The inner high pressure turbine 46 includes an inner turbine nozzle 70 downstream of the inner combustor 18 and having a plurality of inner high pressure turbine stator vanes 72. The inner high pressure turbine 46 further includes a plurality of inner high pressure turbine blades 74 mounted to the high pressure rotor 50 downstream of the inner high pressure turbine stator vanes 72. A diffusing duct 75 downstream of the inner high pressure turbine 46 diffuses the inner combustion gases 45 exiting the inner high pressure turbine 46. Diffusion in the diffusing duct 75 may be about 15%.

In the exemplary embodiment of the engine 10, the inner combustion gases 45 exit the diffusing duct 75 and flow into an inner low pressure turbine 82. The inner low pressure turbine 82 is drivingly connected to the fan and low pressure compressor section 12 through the low pressure rotor 80. The inner combustion gases 45 are discharged from the inner low pressure turbine 82 into a common exhaust duct 76 to be used to provide thrust for the engine 10.

The outer gas generator 16 includes an outer working fluid flowpath 77 within the outer bypass duct 30 and, in downstream serial flow relationship, the fan and low pressure compressor section 12, the outer combustor 20 within the outer bypass duct 30, and an outer low pressure turbine 78. The outer combustor 20 may incorporate a trapped vortex cavity combustor design. A low pressure rotor 80 includes the fan and low pressure compressor section 12 and the outer low pressure turbine 78. The outer low pressure turbine 78 is drivingly connected to the fan and low pressure compressor section 12 through the low pressure rotor 80.

Pressurized air from the fan and low pressure compressor section 12 is mixed with fuel in the outer combustor 20 and ignited, thereby, generating outer combustion gases 83 that flow to the outer low pressure turbine 78 which, in turn, powers the fan and low pressure compressor section 12 and an electrical generator 84 having an electrical generator rotor 86 mounted to the low pressure rotor 80. The outer low pressure turbine 78 includes an outer low pressure nozzle 90 downstream of the outer combustor 20 and having a plurality of outer low pressure turbine stator vanes 92. The outer low pressure turbine 78 further includes a plurality of outer low pressure turbine blades 94 mounted to the low pressure rotor 80 downstream of the outer low pressure turbine stator vanes 92. The outer combustion gases 83 exiting the outer low pressure turbine 78 flow into the common exhaust duct 76 to be used to provide thrust for the engine 10. Thus, the common exhaust duct 76 is downstream of the radially inner and outer gas generators 14 and 16 and the inner high pressure turbine 46 and the outer low pressure turbine 78.

As the outer low pressure turbine 78 rotates, it cuts across a downstream end 100 of the inner working fluid flowpath 48 of the inner gas generator 14. As such, it must have a rotating flowpath 102 for the inner combustion gases 45 to pass through as they exit the inner high pressure turbine 46. The outer low pressure turbine blades 94 of the outer low pressure turbine 78 are mounted on a rotatable turbine shroud 104 which, in turn, is connected to the low pressure rotor 80 via struts 106. The low pressure rotor 80 is illustrated in FIGS. 1 and 2 as having a disk 110 with a disk rim 112 connected to a disk root 114 by a disk web 116. The struts 106 are mounted extending radially outwardly from and around the disk rim 112. The rotating flowpath 102 includes passages 120 between the struts 106.

The struts 106, as illustrated in FIGS. 1 and 2, are aerodynamically designed to be inner low pressure turbine blades 107 of the outer low pressure turbine 78 and extract power and energy from the inner combustion gases 45 exiting the diffusing duct 75 of the inner gas generator 14 downstream of the inner high pressure turbine 46 as they pass through the passages 120 of the outer low pressure turbine 78. This helps power the low pressure rotor 80 including the fan and low pressure compressor section 12. Alternatively, the struts 106 may be only structural in nature and aerodynamically designed not to extract much power or energy if any from the inner combustion gases 45 of the inner high pressure turbine 46 as they pass through the passages 120 between the struts 106.

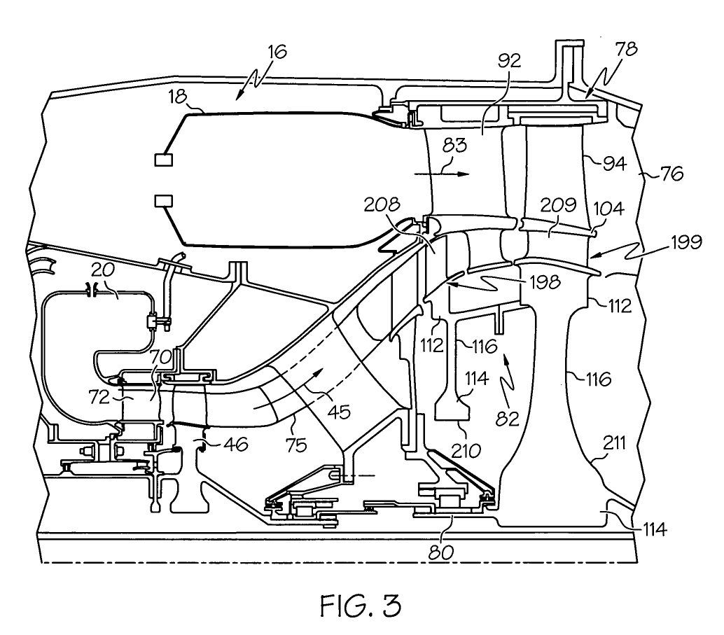

The exemplary inner low pressure turbine 82 illustrated in FIG. 1 has a single stage low pressure turbine stage with inner low pressure turbine blades 107. The inner low pressure turbine 82 may have more than one stage, for example, a two stage inner low pressure turbine 82 illustrated in FIG. 3 has first and second inner low pressure turbine stages 198 and 199 with respective first and second inner low pressure turbine blades 208 and 209. The outer low pressure turbine blades 94 of the outer low pressure turbine 78 are mounted on the rotatable turbine shroud 104 which, in turn, is connected to the low pressure rotor 80 by the second inner low pressure turbine blades 209. The low pressure rotor 80 is illustrated in FIG. 3 as having interconnected first and second disks 210 and 211, each with a disk rim 112 connected to a disk root 114 by a disk web 116. The first and second inner low pressure turbine blades 208 and 209 are mounted extending radially outwardly from and around the disk rims 112 of the first and second disks 210 and 211, respectively. The passages 120 of the rotating flowpath 102 are in between the second inner low pressure turbine blades 209. There may be more than two low pressure turbine stages.

The dual mode aircraft gas turbine engine 10 is primarily for use as a propulsion device for aircraft but may have other applications. Unlike most conventional augmented turbofan engines used world-wide for combat aircraft, it does not require an afterburner to achieve thrust augmentation. The dual mode aircraft gas turbine engine 10 is also designed to operate at very low output with good efficiency. Thus, the engine offers a capability for powering air vehicles requiring both high speed (supersonic) flight at high altitude over considerable distances low speed low altitude flight of substantial duration.

The engine is designed to operate like a high performance dry turbojet capable of sustained supersonic cruise for long distances. It is projected that the “design point” of the engine is at near-maximum rotor speeds and turbine operating temperatures of both the inner and outer gas generators 14 and 16 and the outer low pressure turbine 78 including the inner low pressure turbine blades 107 simultaneously. The engine is also designed for operation at substantial deviation from this design point, which normally produces maximum thrust output, for many potential aircraft applications. This engine design provides a large variation of output with high operating efficiency. This is fundamentally achieved by modulating the fuel split between the radially inner and outer combustors 18 and 20 which changes the energy level of the radially inner and outer gas generators 14 and 16, respectively, without the need for substantial variable geometry hardware to control key flow areas or airflow passage switching devices.

It is recognized that there is an inefficiency relative to a conventional turbofan type operation at low power when the outer combustor 20 is inoperative as the air bypassing the core engine or the inner gas generator 14 is compressed and expanded at low temperature prior to entering the common exhaust duct 76. However, the engine 10 is designed to operate at relatively high pressure ratios across the fan and low pressure compressor section 12 even at low output which results in an increase in thermal efficiency. The engine 10 is also designed to operate at power levels below normal cruise thrust and, thus, the specific fuel consumption should be better than that of a conventional turbofan.

The dual mode engine is designed to operate as a high thrust “dry” (non-afterburning) turbojet for acceleration and high speed with excellent fuel consumption and at a somewhat compromised medium bypass turbofan in the general subsonic area, but offers lower fuel consumption at very low power than a conventional turbofan. The net result is a design for substantial improvement in capability for aircraft that require supersonic flight over long distances.

The electrical generator 84 is capable of producing much more electrical power than conventional aircraft electrical generators when the outer combustor 20 is lit and the outer gas generator 16 is operating. The electrical generator 84 can be configured and constructed with a switching device, not illustrated herein, to operate as an electrical starting motor to turn over and start the engine 10.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention. Accordingly, what is desired to be secured by Letters Patent of the United States is the invention as defined and differentiated in the following claims.

What is claimed is:

1. A dual mode gas turbine engine comprising:
a dual mode fan and low pressure compressor section upstream of radially inner and outer gas generators,
inner and outer working fluid flowpaths of the radially inner and outer gas generators respectively in fluid flow communication with the dual mode fan and low pressure compressor section,
the radially inner and outer gas generators having radially inner and outer combustors respectively, and
an outer low pressure turbine downstream of the outer combustor and drivingly connected to the fan and low pressure compressor section.

2. An engine as claimed in claim 1 further comprising a common exhaust duct downstream of the radially inner and outer gas generators and in fluid flow communication with the inner and outer working fluid flowpaths.

3. An engine as claimed in claim 2 further comprising:
outer low pressure turbine blades of the outer low pressure turbine mounted on a rotatable turbine shroud,
a low pressure rotor including the fan and low pressure compressor section and the outer low pressure turbine,
the outer low pressure turbine being drivingly connected to the fan and low pressure compressor section through the low pressure rotor,
the inner gas generator having an inner low pressure turbine with inner low pressure turbine blades supporting the rotatable turbine shroud on the low pressure rotor, and
the inner working fluid flowpath including a rotating flowpath having passages in between the inner low pressure turbine blades.

4. An engine as claimed in claim 3 further comprising the outer low pressure turbine including a disk with a disk rim connected to a disk root by a disk web and inner low pressure turbine blades mounted around and extending radially outwardly from the disk rim.

5. An engine as claimed in claim 3 further comprising the inner low pressure turbine having two or more inner low pressure turbine stages.

6. An engine as claimed in claim 2 further comprising:
outer low pressure turbine blades of the outer low pressure turbine mounted on a rotatable turbine shroud,
a low pressure rotor including the fan and low pressure compressor section and the outer low pressure turbine,
the outer low pressure turbine being drivingly connected to the fan and low pressure compressor section through the low pressure rotor, and
the inner working fluid flowpath including a rotating flowpath having passages between substantially structural struts supporting the rotatable turbine shroud on the low pressure rotor.

7. An engine as claimed in claim 1 further comprising the radially inner gas generator including a high pressure compressor with a radial outflow centrifugal compressor stage.

8. An engine as claimed in claim 7 further comprising a common exhaust duct downstream of the radially inner and outer gas generators and in fluid flow communication with the inner and outer working fluid flowpaths.

9. An engine as claimed in claim 8 further comprising:
outer low pressure turbine blades of the outer low pressure turbine mounted on a rotatable turbine shroud,
a low pressure rotor including the fan and low pressure compressor section and the outer low pressure turbine,
the outer low pressure turbine being drivingly connected to the fan and low pressure compressor section through the low pressure rotor,
the inner gas generator having an inner low pressure turbine with inner low pressure turbine blades supporting the rotatable turbine shroud on the low pressure rotor, and
the inner working fluid flowpath including a rotating flowpath having passages in between the inner low pressure turbine blades.

10. An engine as claimed in claim 9 further comprising the outer low pressure turbine including a disk with a disk rim connected to a disk root by a disk web and inner low pressure turbine blades mounted around and extending radially outwardly from the disk rim.

11. An engine as claimed in claim 9 further comprising the inner low pressure turbine having two or more inner low pressure turbine stages.

12. An engine as claimed in claim 8 further comprising:
outer low pressure turbine blades of the outer low pressure turbine mounted on a rotatable turbine shroud,
a low pressure rotor including the fan and low pressure compressor section and the outer low pressure turbine,
the outer low pressure turbine being drivingly connected to the fan and low pressure compressor section through the low pressure rotor, and
the inner working fluid flowpath including a rotating flowpath having passages between substantially structural struts supporting the rotatable turbine shroud on the low pressure rotor.

13. An engine as claimed in claim 3 further comprising an electrical generator having an electrical generator rotor mounted to the low pressure rotor.

14. An engine as claimed in claim 13 further comprising:
outer low pressure turbine blades of the outer low pressure turbine mounted on a rotatable turbine shroud,
a low pressure rotor including the fan and low pressure compressor section and the outer low pressure turbine,
the outer low pressure turbine being drivingly connected to the fan and low pressure compressor section through the low pressure rotor,
the inner gas generator having an inner low pressure turbine with inner low pressure turbine blades supporting the rotatable turbine shroud on the low pressure rotor, and
the inner working fluid flowpath including a rotating flowpath having passages in between the inner low pressure turbine blades.

15. An engine as claimed in claim 14 further comprising the outer low pressure turbine including a disk with a disk rim connected to a disk root by a disk web and inner low pressure turbine blades mounted around and extending radially outwardly from the disk rim.

16. An engine as claimed in claim 14 further comprising the inner low pressure turbine having two or more inner low pressure turbine stages.

17. An engine as claimed in claim 13 further comprising:
outer low pressure turbine blades of the outer low pressure turbine mounted on a rotatable turbine shroud,
a low pressure rotor including the fan and low pressure compressor section and the outer low pressure turbine,
the outer low pressure turbine being drivingly connected to the fan and low pressure compressor section through the low pressure rotor, and
the inner working fluid flowpath including a rotating flowpath having passages between substantially structural struts supporting the rotatable turbine shroud on the low pressure rotor.

18. An engine as claimed in claim 7 further comprising the inner combustor being a reverse flow annular combustor and a common exhaust duct downstream of the radially inner and outer gas generators and in fluid flow communication with the inner and outer working fluid flowpaths.

19. An engine as claimed in claim 18 further comprising:
outer low pressure turbine blades of the outer low pressure turbine mounted on a rotatable turbine shroud,
a low pressure rotor including the fan and low pressure compressor section and the outer low pressure turbine,
the outer low pressure turbine being drivingly connected to the fan and low pressure compressor section through the low pressure rotor,
the inner gas generator having an inner low pressure turbine with inner low pressure turbine blades supporting the rotatable turbine shroud on the low pressure rotor, and
the inner working fluid flowpath including a rotating flowpath having passages in between the inner low pressure turbine blades.

20. An engine as claimed in claim 19 further comprising the inner low pressure turbine having two or more inner low pressure turbine stages.

21. An engine as claimed in claim 19 further comprising an electrical generator having an electrical generator rotor mounted to the low pressure rotor.

22. An engine as claimed in claim 21 further comprising the electrical generator being operable to function as an electrical starting motor to turn over and start the engine.

23. An engine as claimed in claim 22 further comprising a switching device to switch the electrical generator between electrical generating and starting functions.

24. An engine as claimed in claim 13 further comprising the electrical generator being operable to function as an electrical starting motor to turn over and start the engine.

25. An engine as claimed in claim 24 further comprising a switching device to switch the electrical generator between electrical generating and starting functions.
